(19) United States
(12) Patent Application Publication
(10) Pub. No.: US 2006/0082678 A1
(43) Pub. Date: Apr. 20, 2006

(54) Document camera with light compensation functionality

(75) Inventors: Chi-Hsien Shih, Chung Ho City (TW); Shi-Mu Sun, Chung Ho City (TW); Lien-Kai Chou, Chung Ho City (TW); Rein-Wein Lin, Chung Ho City (TW)

Correspondence Address: BIRCH STEWART KOLASCH & BIRCH, PO BOX 747, FALLS CHURCH, VA, 22040-0747, US

(73) Assignee: AverMedia TECHNOLOGIES, INC.

(21) Appl. No.: 11/138,435

(22) Filed: May 27, 2005

(30) Foreign Application Priority Data
Oct. 18, 2004 (TW) 93131597

(51) Int. Cl. H04N 5/222

(52) U.S. Cl. 348/370

(57) ABSTRACT

A document camera with light compensation functionality includes a camera securing to a base. The document camera has an emitting-adjustable light source. A sensor, installed on top of the camera, measures the light in the surroundings and outputs an analog signal. A converter transforms the analog signal into a digital signal. A light-computing unit receives the digital signal and produces a signal including an optimum light condition. A light controller controls the intensity of the light of the emitting-adjustable light source according to the signal including the optimum light condition outputted from the light-computing unit.

### RELATED APPLICATIONS

The present application is based on, and claims priority from, Taiwan Application Serial Number 93131597, filed Oct. 18, 2004, the disclosure of which is hereby incorporated by reference herein in its entirety.

### BACKGROUND

1. Field of Invention

The present invention relates to a document camera. More particularly, the present invention relates to a document camera with light compensation functionality.

2. Description of Related Art

Traditionally, a common presentation apparatus is a projector presented through a slide. With the advancement of technologies, the useful presentation apparatus at present includes a projector with a LCD, a laptop and a document camera.

The document camera may directly present an object on a monitor without previously transforming the object, such as a document or material, into an image file or a document file. The document camera uses a digital camera to capture an image of the object and directly presents the image on a monitor. Therefore, by using the document camera, a presenter will save a lot of time without preparing the presentation data previously.

When the document camera is used, if the intensity of the light in the surroundings is too high, it will cause the image of the object presented on the monitor becomes dark so that the image will not to be identified easily. Therefore, a solution used to solve the above problems is necessary for the document camera manufactures.

### SUMMARY

It is therefore an objective of the present invention to provide a document camera with light compensation functionality for obtaining an excellent effect of projection.

According to the foregoing objectives of the invention, a document camera with light compensation functionality is provided. The document camera comprises a camera securing to a base and the camera has an emitting-adjustable light source. The camera measures the intensity of the light in the surroundings through a light sensor on top of the camera and outputs a corresponding analog signal to a signal converter. The signal converter converts the analog signal into a digital signal. A light-computing unit receives the digital signal and calculates a signal including an optimum light condition for the camera according to the digital signal. A light controller controls the intensity of the light of the emitting-adjustable light source according to the signal including the optimum light condition outputted from the light-computing unit. The emitting-adjustable light source is a light source having a plurality of LEDs or an emitting-adjustable light bulb.

As described in above, according to the application of the document camera with light compensation functionality of the present invention, measures the intensity of the light in the surroundings, calculates a signal having an optimum light condition and controls the intensity of the light of the camera. According to the application of light compensation functionality, which can prevent the effect of projection tend to unexpected when the intensity of the light in the surroundings is in a high level, such as the image of the object becomes dark and not easily to be identified, and further to enhance the effect of projection.

It is to be understood that both the foregoing general description and the following detailed description are by examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram illustrating a document camera with light compensation functionality according to a preferred embodiment of the present invention; and

FIG. 2 is a block diagram illustrating the related light compensation components in the document camera according to a preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

As described in above, when the intensity of the light in the surroundings for a document camera is too high or too low, the effect of projection will become very bad. To solve the above question, the present invention provides a document camera with light compensation functionality, which measures the intensity of the light in the surroundings for the document camera and calculates an optimum intensity of the light, thereby to enhance the effect of projection.

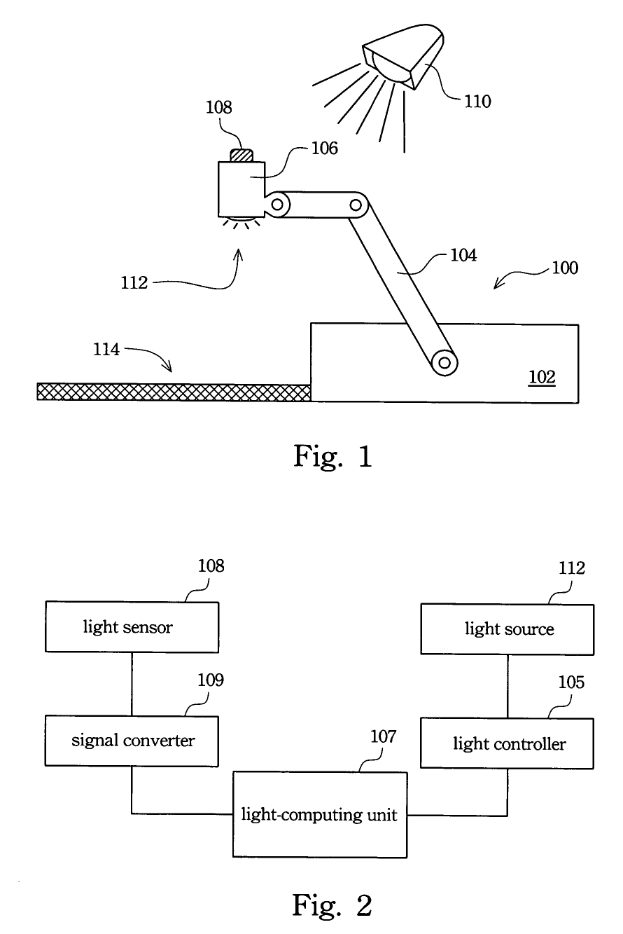

Referring to FIG. 1, which is a schematic diagram illustrating a document camera with light compensation functionality according to a preferred embodiment of the present invention. A document camera 200 is used to capture an image of a document 114 through a camera 106. The camera 106 is secured to a base 102 through an arm 104. In addition to the light emitting from a light source 112, the light source 112 is installed on bottom of the camera 106, if the intensity of the light 110 in the surroundings is too high, it will cause the image of the object presented on the monitor becomes dark so that the image will not to be identified easily. In this embodiment, the intensity of the light 110 in the surroundings is measured through a light sensor 108, wherein the light sensor 108 is installed on top of the camera 106. A signal measured by the light sensor 108 is used to compensate for the light emitting from the light source 112.

FIG. 2 is a block diagram illustrating the related light compensation components in the document camera according to a preferred embodiment of the present invention. In order to carry out the above light compensation functionality, the implementation and related components as shown in FIG. 2. The light sensor 108 is used to measure the intensity of the light 110 in the surroundings. A signal converter 109 is connected to the light sensor 108 for converting an analog signal from the light sensor 108 into a digital signal. A light-computing unit 107 is connected to the signal converter 109 for receiving the digital signal from the signal converter 109. The light-computing unit 107 calculates and outputs a signal including an optimum light condition suitable for surroundings, according to the digital signal. A light controller 105 is connected between the light-computing unit 107 and a light source 112 for receiving the signal including an optimum light condition from the light-computing unit 107. When the light controller 105 receives the signal including the optimum light condition, the light controller 105 controls the intensity of the light of the light source so as to enhance the effect of projection.

In FIG. 2, in addition to the arrangement of the light sensor 108 (installed on top of the camera 106) and the light source 112 both must to be fixed in a specific place, the arrangement of the other components may be designed in different places, respectively. For example, the light controller 105, the light-computing unit 107 or the signal converter 109 could be made in the form of circuitry on a printed circuit board (PCB), or made in the form of ICs and adhered to a PCB. The light source 112 of the invention is an emitting-adjustable light source such as a light source having a plurality of light-emitting diodes (LEDs), or at least one emitting-adjustable light bulb. The implement of the light source having a plurality of LEDs includes, for example, controls some of LEDs to be turned on and the others to be turned off, thereby to achieve an object of emitting-adjustable.

According to the preferred embodiment of the present invention, as described in above, the application of the document camera with light compensation functionality of the invention includes measures the intensity of the light in the surroundings, calculates an optimum intensity of the light and adjusts the intensity of the light of the light source to be outputted. According to the function of light compensation, which can prevent the effect of projection tend to unexpected when the intensity of the light in the surroundings is in a high level, such as the image of the object becomes dark and not easily to be identified, thereby to further enhance the effect of projection.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A document camera with light compensation functionality, comprising:
a camera, wherein the camera is secured to a base and said camera has an emitting-adjustable light source;
a light sensor, wherein said light sensor is arranged on top of said camera, for receiving a light in the surroundings;
a signal converter, wherein said signal converter is connected to said light sensor, for receiving an analog signal from said light sensor and converting the analog signal into a digital signal;
a light-computing unit, wherein said light-computing unit is connected to said signal converter, for receiving the digital signal and calculating a signal including an optimum light condition for the document camera; and
a light controller, wherein said light controller is connected to said light-computing unit and said emitting-adjustable light source, for controlling the intensity of the light of said emitting-adjustable light source according to the signal including the optimum light condition.

2. The document camera of claim 1, wherein said emitting-adjustable light source is a light source having a plurality of light emitting diodes (LEDs).

3. The document camera of claim 1, wherein said emitting-adjustable light source is an emitting-adjustable light bulb.
